(19) United States
(12) Patent Application Publication
(10) Pub. No.: US 2016/0133229 A1
(43) Pub. Date: May 12, 2016

(54) SIGNAL PROCESSING DEVICE AND SIGNAL PROCESSING METHOD

(71) Applicant: Panasonic Intellectual Property Management Co., Ltd., Osaka (JP)

(72) Inventor: Masanobu INOE, Okayama (JP)

(21) Appl. No.: 14/933,007

(22) Filed: Nov. 5, 2015

(30) Foreign Application Priority Data
Nov. 7, 2014 (JP) 2014-226921
Oct. 27, 2015 (JP) 2015-210319

(51) Int. Cl. G09G 5/10; G09G 3/20

(52) U.S. Cl. CPC G09G 5/10; G09G 3/2003; G09G 2320/0233; G09G 2340/02

(57) ABSTRACT

A signal processing device is provided that is capable of suppressing incongruity of color change in an image area while relieving fatigue of a user viewing content data to be displayed. The signal processing device includes a calculator, a setting unit, and a converter. The calculator sets a ratio to a display area of a first area in which a character is mainly displayed in the display area of the content data, and sets a ratio to the display area of a second area in which an object other than character such as an image is mainly displayed. The setting unit sets a target color temperature based on the ratio set by the calculator. The converter changes a current color temperature of the content data to the target color temperature set by the setting unit.

### BACKGROUND OF THE INVENTION

1. Field of the Invention

The present disclosure relates to a signal processing method and a signal processing device for performing signal processing to content data to be input.

2. Description of the Related Art

Unexamined Japanese Patent Publication No. 2013-257457 discloses a display device, and a display controlling method and a program. The display device has a display unit that outputs an image signal, and a signal processor that performs controlling of the image signal to be output to the display unit. The signal processor performs controlling that gradually decreases a color temperature of the image signal in accordance with an elapsed time from an observation start time of the display unit. By decreasing the color temperature, it is possible to reduce a blue component, and to relieve fatigue of a user.

The present disclosure provides a signal processing device capable of suppressing incongruity of color change in an image area while relieving the fatigue of the user viewing the content data to be displayed.

### SUMMARY OF THE INVENTION

A signal processing device of the present disclosure includes a calculator that divides a display area of content data into a plurality of areas including a first area for mainly displaying a character and a second area for mainly displaying an object other than character, and calculates each of a first ratio of the first area to the display area and a second ratio of the second area to the display area. Further, the signal processing device includes a setting unit that sets a target color temperature of the content data based on the first ratio and the second ratio, and a converter that changes a color temperature of the content data to the target color temperature.

The signal processing device of the present disclosure is effective to suppress incongruity of color change in an image area while relieving fatigue of a user viewing the content data to be displayed.

### BRIEF DESCRIPTION OF DRAWINGS

FIG. 1 is a block diagram illustrating one configuration example of a display device in a first exemplary embodiment;

FIG. 2 is a diagram illustrating one example of a gray level histogram of a first area in the first exemplary embodiment;

FIG. 3 is a diagram illustrating one example of a gray level histogram of a second area in the first exemplary embodiment;

FIG. 4 is a flowchart for describing one example of operation of a calculator in the first exemplary embodiment;

FIG. 5 is a flowchart for describing one example of operation of a setting unit in the first exemplary embodiment;

FIG. 6 is a diagram for describing one example of a color temperature setting in the first exemplary embodiment;

FIG. 7 is an explanatory diagram of one example of a color temperature conversion method for a converter in the first exemplary embodiment;

FIG. 8 is an explanatory diagram of another example of the color temperature conversion method for the converter in the first exemplary embodiment;

FIG. 9 is a diagram illustrating color temperature change in the first exemplary embodiment;

FIG. 10 is a block diagram illustrating one configuration example of a display device in a second exemplary embodiment;

FIG. 11 is a diagram illustrating one example of a color temperature setting in the second exemplary embodiment;

FIG. 12 is a block diagram illustrating one configuration example of a display device in a third exemplary embodiment; and

FIG. 13 is a diagram illustrating one example of a color temperature setting in the third exemplary embodiment.

### DETAILED DESCRIPTION OF THE PREFERRED EMBODIMENTS

Exemplary embodiments are described in detail below with proper reference to the drawings. However, an unnecessarily detailed description may be omitted. For example, a detailed description of an already well known matter and a duplicate description for substantially the same configuration may be omitted. This is to avoid the description below is unnecessarily redundant, and to facilitate understanding of those skilled in the art.

Incidentally, the inventor of the present invention provides accompanying drawings and the description below so that those skilled in the art sufficiently understand the present disclosure, and does not intend to limit the claimed subject matter by these drawings and the description.

### First Exemplary Embodiment

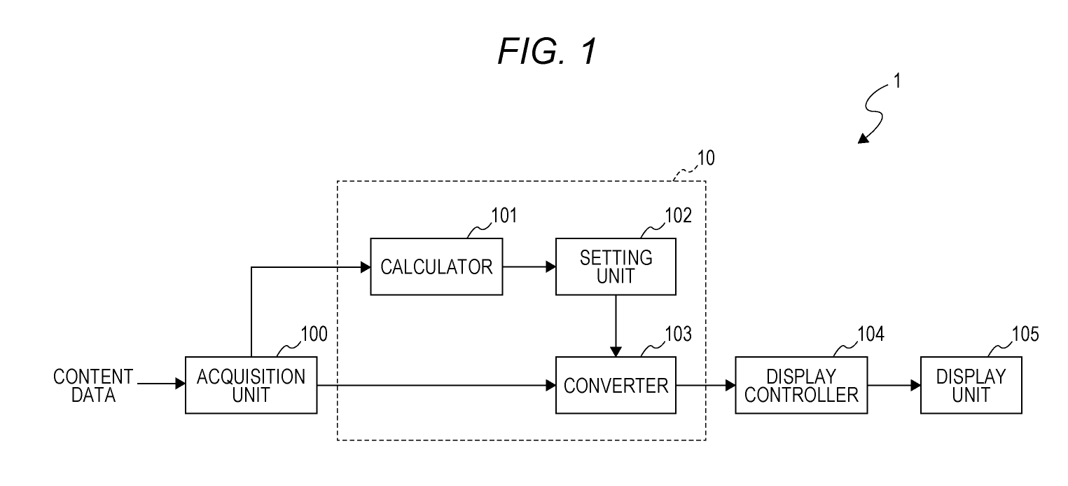

A first exemplary embodiment is described below with reference to FIG. 1 to FIG. 9.

[1-1. Configuration]

FIG. 1 is a block diagram illustrating display device 1 in the first exemplary embodiment. As illustrated in FIG. 1, display device 1 includes acquisition unit 100, signal processing device 10, display controller 104, and display unit 105. Further, signal processing device 10 includes calculator 101, setting unit 102, and converter 103.

Acquisition unit 100 is an input unit of content data. Here, the content data is digital information represented by a picture, an image, a character, or a combination thereof. The content data is the data in a file format conforming to a standard such as MPEG, JPEG, PDF, and BMP, for example.

Calculator 101 divides a display area of the content data input from acquisition unit 100 into a plurality of display areas including a first area for mainly displaying a character and a second area for mainly displaying an object other than character, and calculates each of a first ratio of the first area to the display area and a second ratio of the second area to the display area. Here, “a character is mainly displayed” represents that the character is displayed in ½ or more areas of the display area. Similarly, “an object other than character is mainly displayed” represents that the object other than character is displayed in ½ or more areas of the display area. Incidentally, the ratio to the area of the character or the object other than character for determining the first area and the second area is not limited to ½.

Setting unit 102 sets a target color temperature obtained when the content data is displayed in accordance with the first ratio and the second ratio calculated by calculator 101. Incidentally, the color temperature indicates a hue obtained when a gray scale including white is displayed. When the color temperature is low, display is close to red, and when the color temperature is high, the display is close to blue. The color temperature of the present disclosure represents not only color on a black body radiation locus represented on a chromaticity diagram but also color of coordinates including a vicinity of the black body radiation locus that is so called correlated color temperature.

Converter 103 changes a color temperature obtained when the content data acquired by acquisition unit 100 is displayed to the target color temperature set by setting unit 102. Although the color temperature can be changed to the set color temperature immediately, the color temperature can also be changed to the target color temperature gradually with a time course.

Display controller 104 performs processing for displaying, on display unit 105 of a subsequent stage, the content data in which the color temperature is changed by converter 103.

Display unit 105 is a display, and is configured by a liquid crystal display, an organic EL display, or a plasma display, for example.

[1-2. Operation]

For the signal processing device configured as described above, the operation is described below.

[1-2-1. Operation of Calculator]

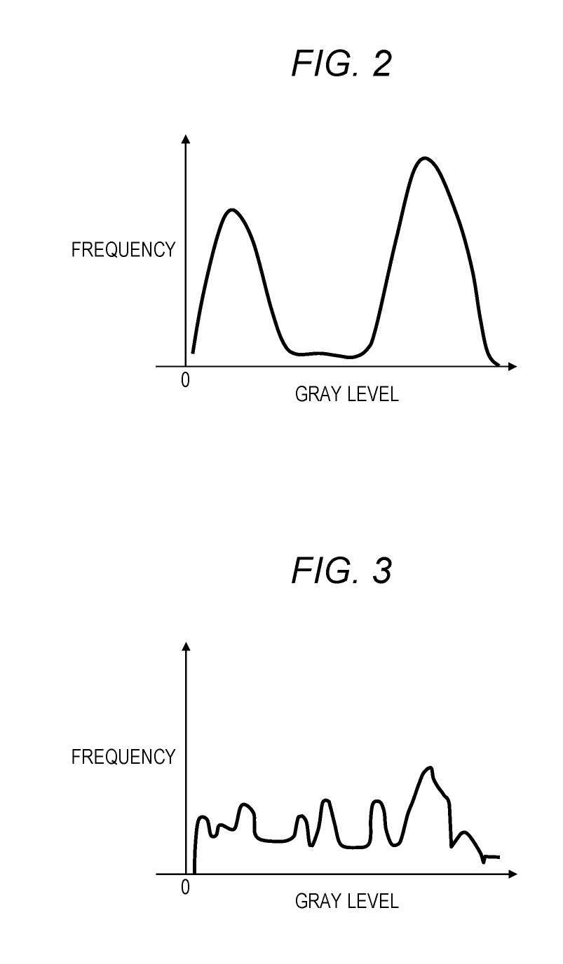

FIG. 2 is a diagram illustrating one example of a gray level histogram of a first area in the first exemplary embodiment. FIG. 3 is a diagram illustrating one example of a gray level histogram of a second area in the first exemplary embodiment. In FIG. 2 and FIG. 3, a horizontal axis represents a gray level, and a vertical axis represents a frequency of each gray level.

As illustrated in FIG. 2, in a gray level histogram of the first area in which the character is mainly displayed, a gray level of the character and a gray level of a background are each gathered, and the histogram is divided into two major peaks. Further, as illustrated in FIG. 3, in an area that displays an image and is one example of the second area, gray levels are distributed overall.

Calculator 101 discriminates which area an area of a discrimination object corresponds to by using a feature of the gray level histogram of the first area illustrated in FIG. 2 and a feature of the gray level histogram of the second area illustrated in FIG. 3.

Here, the gray level can be one in which signal levels of RGB signals are summed and averaged, and also can be a luminance value obtained by the RGB signals. The luminance value is represented by following (Equation 1), for example.

Luminance value=0.3R+0.6G+0.1B (Equation 1)

Here, in (Equation 1), R, G, and B represent signal levels of a red signal, a green signal, and a blue signal, respectively.

Further, calculator 101 can add discrimination by an edge value in the area in addition to discrimination of the area by the gray level histogram. Calculator 101 performs the discrimination of the area by using that there are more large edge-changes than small edge-changes in the first area and that there are more small edge-changes in the second area.

In calculator 101, ratios of the first area and the second area in the display area are calculated from a number of the first areas and a number of the second areas obtained by such discrimination method of the area mentioned in the above example.

Incidentally, in calculation of the ratios, an area that has the same background color and does not have the character, such as a margin, can be treated as included in the second area, and also can be treated as not included in any of the first and the second areas.

Further, calculator 101 can excludes from the first area, an area having chroma of a background color that is equal to or greater than a predetermined value in the first area.

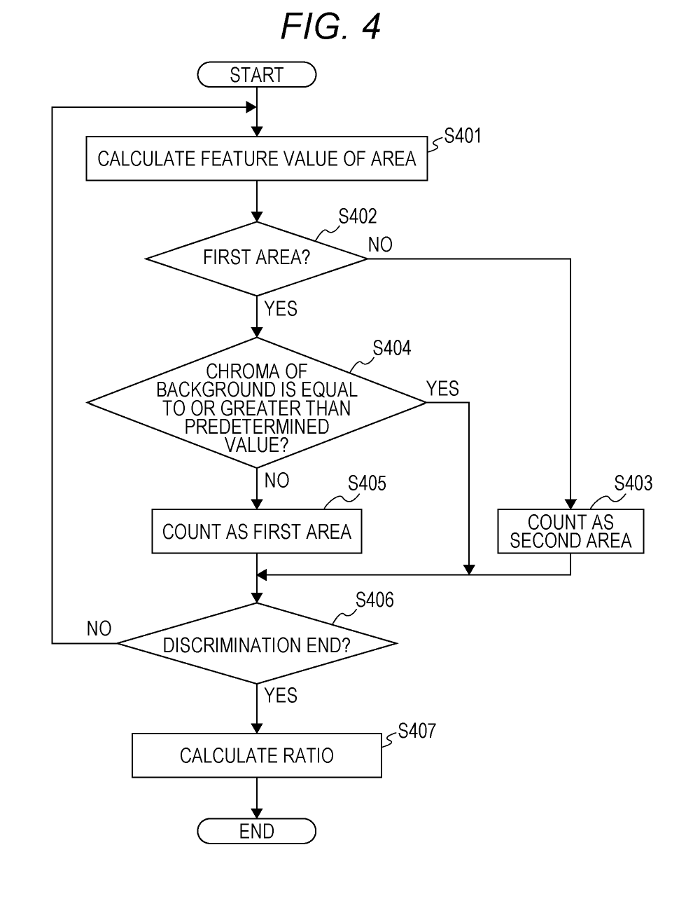

FIG. 4 is a flowchart for describing one example of operation of calculator 101 in the first exemplary embodiment. FIG. 4 is one example of a processing flow in a case where a background color of the first area is considered. FIG. 4 is one example in a case where the gray level histogram is used for area discrimination.

Calculator 101 divides the display area of the content data into a plurality of predetermined unit areas, and performs discrimination whether the plurality of predetermined unit areas is the first area or the second area for each of the areas.

(Step S401) Calculator 101 reads an object area and calculates a feature value (for example, gray level histogram) of the area.

(Step S402) Calculator 101 determines whether or not the area is the first area from the feature value calculated in step S401. Calculator 101 proceeds to step S403 when determining that the area is not the first area, and proceeds to step S404 when determining that the area is the first area.

(Step S403) Calculator 101 counts the area as the second area, and proceeds to step S406.

(Step S404) Calculator 101 discriminates whether or not chroma of the background in the area is equal to or greater than a predetermined value. Calculator 101 excludes from the first area, the area having chroma of a background color that is equal to or greater than a predetermined value, and proceeds to step S406. Calculator 101 proceeds to step S405 when the chroma of the background is less than the predetermined value.

(Step S405) Calculator 101 counts the area as the first area, and proceeds to step S406.

(Step S406) Calculator 101 determines whether or not the discrimination of an entire area has been completed, and proceeds to step S407 when the discrimination has been completed. Calculator 101 returns to step S401 when the discrimination of the entire area has not been completed.

(Step S407) Calculator 101 calculates the first ratio and the second ratio from a number of counts of the first area and a number of counts of the second area.

[1-2-2. Operation of Setting Unit]

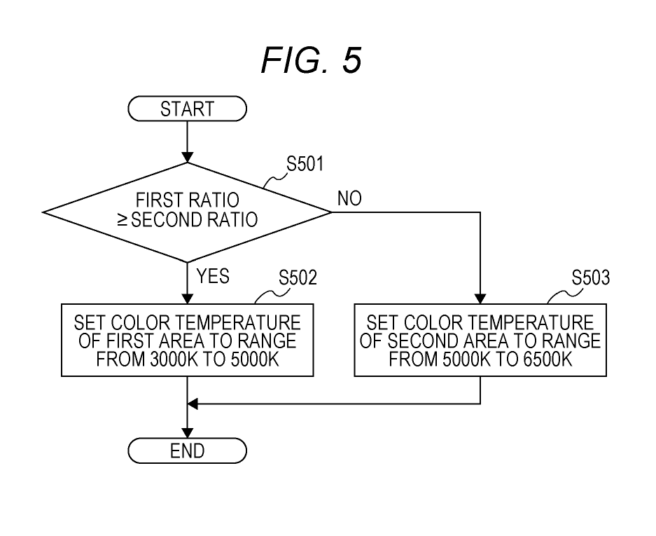

FIG. 5 is a flowchart for describing one example of operation of setting unit 102.

(Step S501) Setting unit 102 proceeds to step S502 when the first ratio is equal to or greater than the second ratio, and proceeds to step S503 when the second ratio is greater.

(Step S502) Setting unit 102 sets the color temperature of the first area to a range from 3000K and 5000K. For example, if the first ratio is 100%, the color temperature is set to 3000K. If the first ratio is around 50%, the color temperature is set to 5000K. If the first ratio is between 50% and 100%, the color temperature is set between 3000K and 5000K in accordance with the ratio.

(Step S503) Setting unit 102 sets the color temperature of the second area to a range from 5000K to 6500K. For example, if the second ratio is 100%, the color temperature is set to 6500K. If the second ratio is around 50%, the color temperature is set to 5000K. If the second ratio is between 50% and 100%, the color temperature is set to a range from 5000K to 6500K in accordance with the ratio.

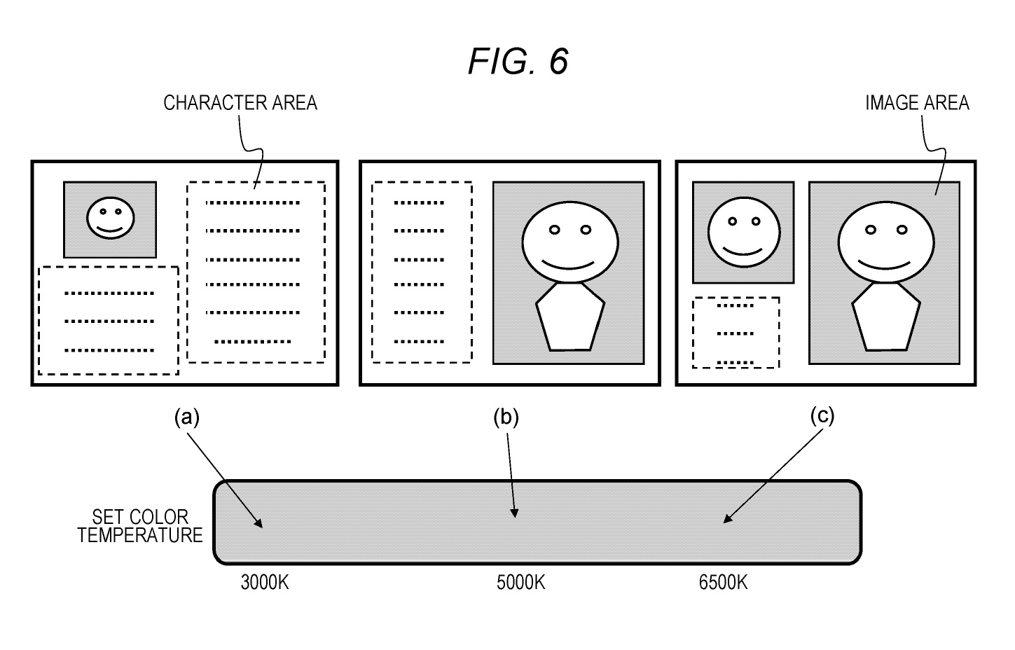

FIG. 6 is a diagram for describing one example of a color temperature setting.

Since the first ratio is between 50% and 100% in (a) of FIG. 6, the color temperature is set between 3000K and 5000K. In (a) of FIG. 6, the color temperature is set to a value close to 3000K. Since the first ratio is around 50% in (b) of FIG. 6, the color temperature is set to 5000K. Since the second ratio is between 50% and 100% in (c) of FIG. 6, the color temperature is set between 5000K and 6500K. In (c) of FIG.6, the color temperature is set to a value close to 6500K.

As illustrated in FIG. 6, the color temperature is set lower as the first ratio in the display area is greater.

[1-2-3. Operation of Converter]

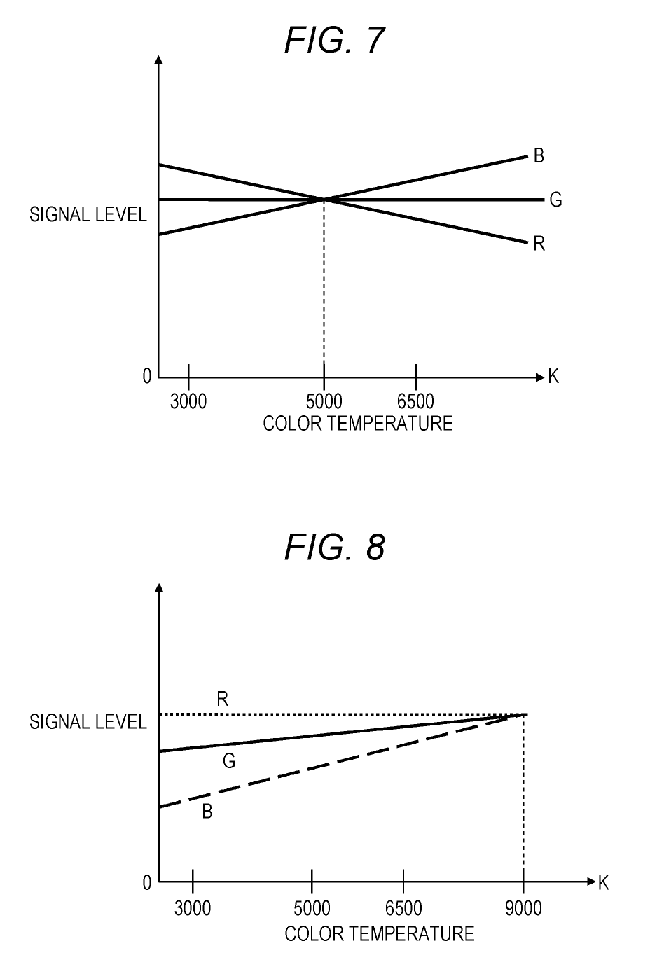

FIG. 7 is a diagram illustrating one example of a color temperature conversion method of converter 103 in the first exemplary embodiment. FIG. 7 is an example in which the color temperature to be displayed is 5000K when the RGB signals have the same level. When the color temperature is changed, processing is performed that multiplies a predetermined gain to each of the RGB signals to change the ratios of the RGB signals. When the color temperature is increased, a level of a B signal is changed to be increased and a level of an R signal is changed to be decreased. When the color temperature is decreased, the level of the B signal is changed to be decreased and the level of the R signal is changed to be increased.

FIG. 8 is a diagram illustrating another example of the color temperature conversion method of converter 103 in the first exemplary embodiment. FIG. 8 is an example in which the color temperature to be displayed is 9000K when the RGB signals have the same level. When the color temperature is decreased, the levels of the B signal and the R signal are changed to be decreased by multiplying a predetermined gain to each of the RGB signals.

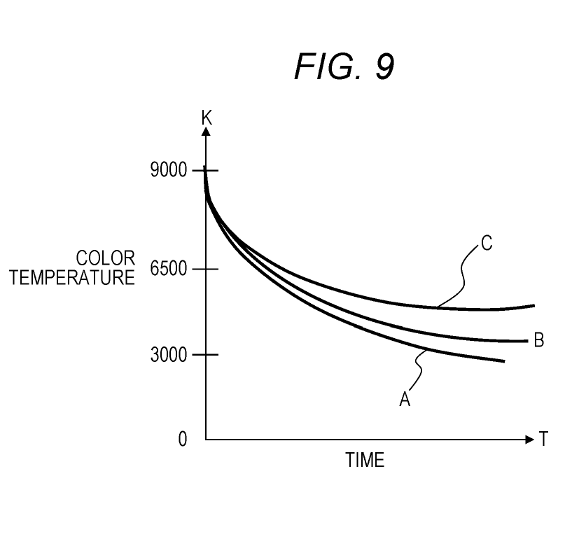

FIG. 9 is a diagram illustrating color temperature change in the first exemplary embodiment. As illustrated, FIG. 9 is an example in a case where converter 103 gradually performs the color temperature change with a time course. In FIG. 9, A is a color temperature when the first ratio is greater. C is a color temperature when the second ratio is greater. B is a color temperature when the first ratio and the second ratio are the almost same value. The target color temperature is a lower color temperature when the first ratio is greater (Color temperature A of FIG. 9), and is a higher color temperature when the second ratio is greater (Color temperature C of FIG. 9). In FIG. 9, it can be seen that color temperature A to C draw gentle curves toward the target color temperatures with a time course and gradually change the color temperatures. Thus, by gradually changing the color temperature, the color temperature can be changed so that the user does not recognize incongruity, by utilizing adaptability to the color of a user viewing display unit 105.

[1-3. Effects]

As described above, in the present exemplary embodiment, calculator 101 divides the display area of the content data into a plurality of areas, and discriminates each of the areas between the first area in which the character is mainly displayed and the second area in which the object other than character such as the image is mainly displayed, and sets the first ratio to the display area of the first area and the second ratio to the display area of the second area. Setting unit 102 sets the target color temperature of when the content data is displayed in accordance with the first ratio and the second ratio calculated by calculator 101. Converter 103 changes the color temperature of when the content data is displayed to the target color temperature set by setting unit 102.

Thus, in the content data, a decrement of the color temperature setting is set greater when the first ratio is greater, and the decrement of the color temperature setting is set smaller when the second ratio is greater. Therefore, when the first area is greater, it is possible to largely reduce a blue light emitting component that is considered to increase fatigue of the user. When the second area is greater, the content data can be displayed so that the blue light emitting component is reduced and incongruity in an original hue of the image is suppressed. Here, the blue light emitting component is a light component of a wavelength of a range about from 400 nm to 500 nm, which is called blue light, for example.

Further, in the present exemplary embodiment, calculator 101 excludes from the first area, an area having chroma of a background color that is equal to or greater than a predetermined value in the first area.

Thus, even when the area is determined as being the first area from the gray level histogram and the like, the decrement of the color temperature is made to be small without discriminating the area as being the first area if the chroma of the background is equal to or greater than the predetermined value. Therefore, it is possible to reduce the blue light emitting component, and it is possible to obtain display that does not largely break a hue relationship between the character and the background color.

### Second Exemplary Embodiment

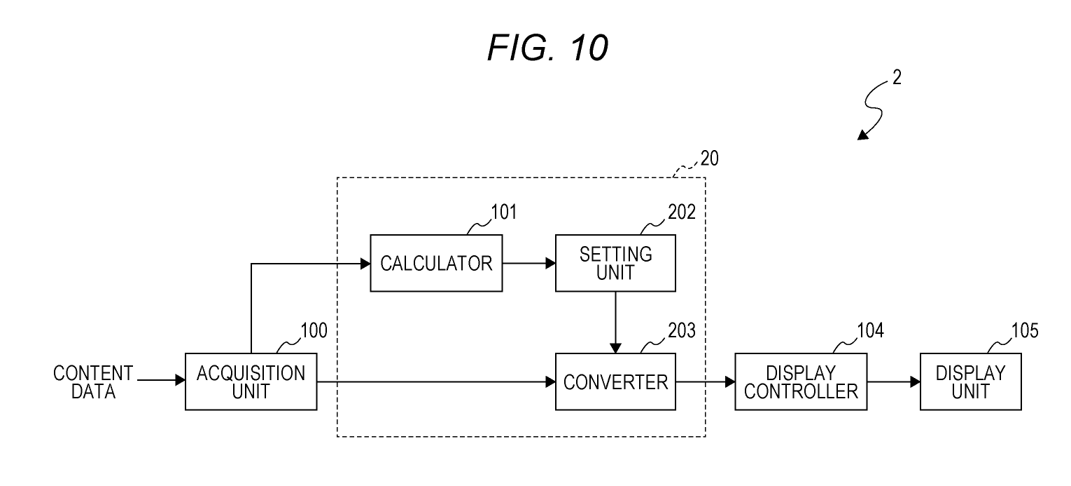

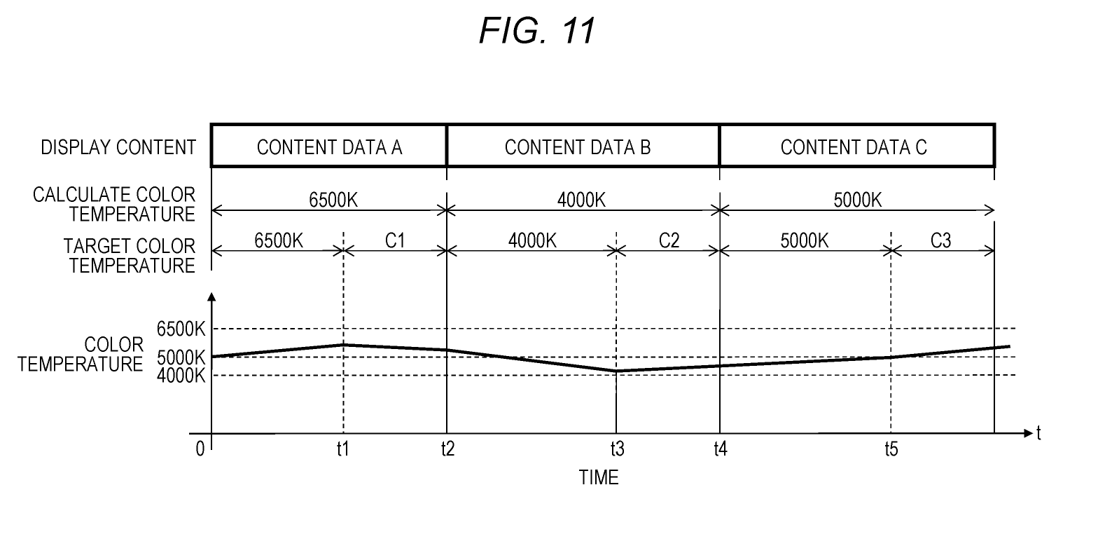

A second exemplary embodiment is described below with reference to FIG. 10 to FIG. 11.

[2-1. Configuration]

FIG. 10 is a block diagram illustrating one configuration example of a display device 2 in the second exemplary embodiment. As illustrated in FIG. 10, display device 2 includes acquisition unit 100, signal processing device 20, display controller 104, and display unit 105. Signal processing device 20 includes calculator 101, setting unit 202, and converter 203. Here, for an element that performs the same operation as the first exemplary embodiment, the same reference numeral is given, and description is omitted. In the present exemplary embodiment, operation of setting unit 202 and converter 203 is mainly described.

Setting unit 202 sets a target color temperature of when display unit 105 displays content data in accordance with the first ratio and the second ratio calculated by calculator 101. Setting unit 202 calculates a subsequent target color temperature, and then sets a color temperature between a current target color temperature and the subsequent target color temperature, as a target color temperature.

[2-2. Operation]

For the signal processing device configured as described above, the operation is described below.

FIG. 11 is a diagram illustrating one example of a color temperature setting method in the second exemplary embodiment.

In FIG. 11, a horizontal axis represents time, and the content data is sequentially displayed on display unit 105 in order of content data A from time 0, content data B from time t2, and content data C from time t4. As illustrated in FIG. 11, setting unit 202 calculates target color temperatures of 6500K for content data A, 4000K for content data B, and 5000K for content data C, with the method of the first exemplary embodiment.

First, setting unit 202 sets the target color temperature 6500K of content data A. Then, setting unit 202 calculates the target color temperature of content data B at time t1 before time t2, and then replaces the target color temperature to color temperature C1 between the target color temperature 6500K of content data A and the target color temperature 4000K of content data B. Then, setting unit 202 sets the target color temperature to 4000K after content data B is displayed from time t2. Further, setting unit 202 calculates the target color temperature of content data C at time t3 before time t4, and then replaces the target color temperature to color temperature C2 between the target color temperature 4000K of content data B and the target color temperature 5000K of content data C. Setting unit 202 sets the target color temperature to 5000K after content data C is displayed from time t4. Setting unit 202 calculates the target color temperature of a subsequent content (not illustrated) at time t5 before display of content data C is finished, and then replaces the target color temperature to color temperature C3 between the target color temperature 5000K of content data C and the target color temperature of the subsequent content.

As illustrated in FIG. 11, converter 203 changes the color temperature of content data A so that the color temperature of content data A approaches the target color temperature 6500K, at a display start time. Then, converter 203 changes the color temperature of content data A from time t1 so that the color temperature of content data A approaches target color temperature C1. Then, converter 203 changes the color temperature of content data B from time t2 so that the color temperature of content data B approaches the target color temperature 4000K. Then, converter 203 changes the color temperature of content data B from time t3 so that the color temperature of content data B approaches target color temperature C2. Further, converter 203 changes the color temperature of content data C from time t4 so that the color temperature of content data C approaches the target color temperature 5000K. Converter 203 changes the color temperature of content data C from time t5 so that the color temperature of content data C approaches target color temperature C3.

[2-3. Effects]

As described above, in the present exemplary embodiment, setting unit 202 sets the target color temperature in accordance with the first ratio and the second ratio calculated by calculator 201. Setting unit 202 calculates a target color temperature of the content data to be subsequently displayed, and then sets the color temperature between the target color temperature of the content data currently being displayed and the target color temperature of the content data to be subsequently displayed, as a target color temperature of the content data currently being displayed. Converter 203 changes the color temperature of the display content so that the color temperature of the display content approaches the target color temperature set by setting unit 202.

Thus, even when a difference is large between the target color temperature set to the content data currently being displayed and the target color temperature to be set to the content data to be subsequently displayed, it is possible to start change to the subsequent color temperature before display of the content data is switched, to avoid rapid change of the color temperature. Therefore, it is possible to reduce the blue light emitting component, and it is possible to suppress incongruity of the hue received by the user that is generated when the color temperature is largely changed.

### Third Exemplary Embodiment

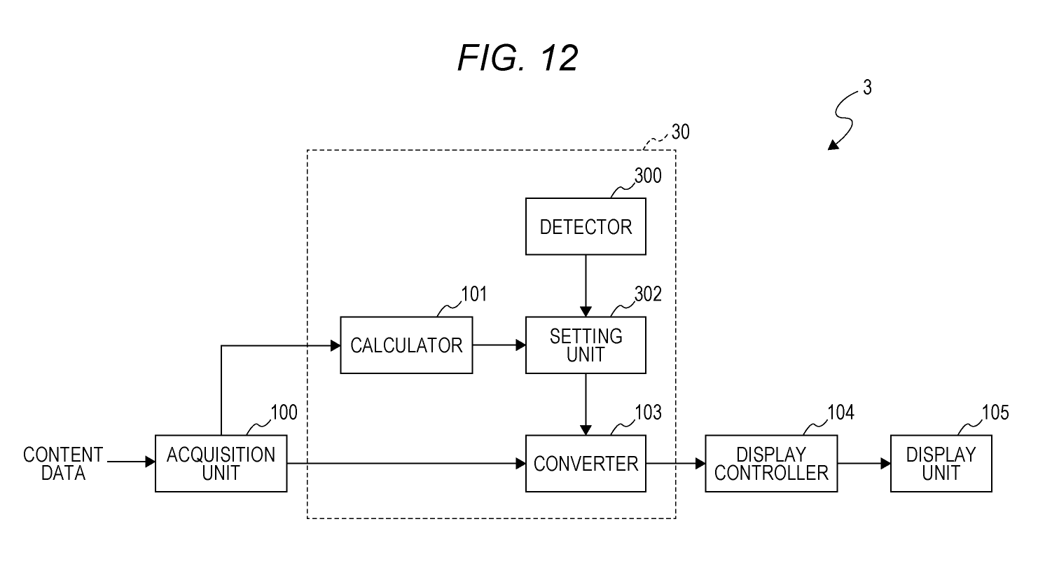

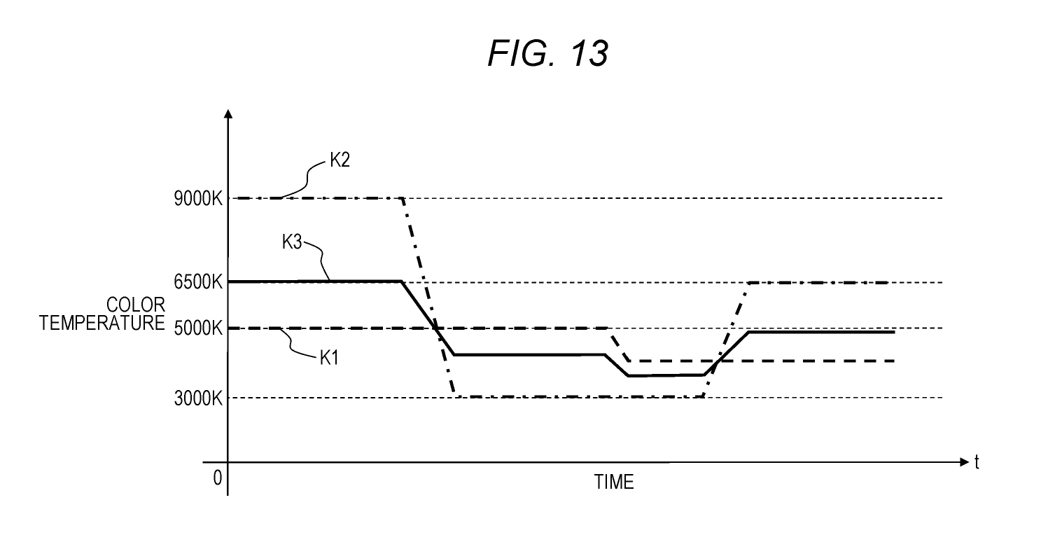

A third exemplary embodiment is described below with reference to FIG. 12 to FIG. 13.

[3-1. Configuration]

FIG. 12 is a block diagram illustrating one configuration example of a display device 3 in the third exemplary embodiment. As illustrated in FIG. 12, display device 3 includes acquisition unit 100, signal processing device 30, display controller 104, and display unit 105. Signal processing device 30 includes calculator 101, setting unit 302, converter 103, and detector 300. Here, for an element that performs the same operation as the first exemplary embodiment, the same reference numeral is given, and description is omitted. In the present exemplary embodiment, operation of setting unit 302 and detector 300 is mainly described.

Detector 300 detects a color temperature of ambient light in an environment in which the display device 3 is used, by a light sensor and the like.

Setting unit 302 sets the target color temperature of when content data is displayed in accordance with the first ratio and the second ratio calculated by calculator 101 and the color temperature of the ambient light detected by detector 300.

Converter 103 changes the color temperature of the content data to be displayed so that the color temperature of the content data to be displayed approaches the target color temperature set by setting unit 302.

[3-2. Operation]

For the signal processing device configured as described above, the operation is described below.

[3-2-1. Operation of Setting Unit]

Setting unit 302 sets the target color temperature of the content data in accordance with the first ratio and the second ratio calculated by calculator 101. At this time, the color temperature is set lower as the first ratio of the first area is greater in the content data. Further, setting unit 302 sets the target color temperature between the color temperature set in accordance with the first ratio and the second ratio calculated by calculator 101 and the color temperature of the ambient light detected by detector 300.

FIG. 13 is a diagram illustrating one example of a color temperature setting in the present exemplary embodiment.

In FIG. 13, a horizontal axis represents time, and a vertical axis represents color temperature. In FIG. 13, K1 is a color temperature set by setting unit 302 in accordance with the first ratio and the second ratio calculated by calculator 101. K2 is a color temperature of a surrounding environment detected by detector 300. K3 is a target color temperature set between color temperature K1 and color temperature K2.

As illustrated in FIG. 13, color temperature K3 is set to a color temperature between color temperature K1 and color temperature K2.

[3-3. Effects]

As described above, in the present exemplary embodiment, setting unit 302 sets the target color temperature between the color temperature set in accordance with the first ratio and the second ratio calculated by calculator 101 and the color temperature of the ambient light detected by detector 300. Converter 103 converts the color temperature of the content data to be displayed to the target color temperature.

Thus, even when there is a large difference between the color temperature set by the first ratio to the display area of the first area of the content data and the second ratio to the display area of the second area and the color temperature of the ambient light in which the signal processing device is used, it is possible to set the target color temperature to a color temperature between both color temperatures. Therefore, it is possible to suppress incongruity of the user generated by a difference between the color temperature set in display unit 105 and the color temperature of the ambient light.

As described above, the exemplary embodiments have been described as illustrations of technique of the present disclosure. For this purpose, the accompanying drawings and the detailed description have been provided.

Accordingly, in the elements described in the accompanying drawings and the detailed description, there may be included not only essential elements for problem solving but also non-essential elements for the problem solving, to illustrate the above technique. Therefore, it should not be certified that those non-essential elements are essential immediately, with that those non-essential elements are described in the accompanying drawings and the detailed description.

Further, since the above described exemplary embodiments are intended to illustrate the technique of the present disclosure, various modifications, substitutions, additions, omissions and the like can be performed within the scope of the claims or the scope of the equivalents of the claims.

The present disclosure is applicable to a signal processing device with a display unit. Specifically, the present disclosure is applicable to a display for a PC, a display for an inside of an airplane, a tablet terminal, a head mount display, a smartphone, and the like.

What is claimed is:

1. A signal processing device comprising:
a calculator that divides a display area of content data into a plurality of areas including a first area for mainly displaying a character and a second area for mainly displaying an object other than character, and calculates each of a first ratio of the first area to the display area and a second ratio of the second area to the display area;
a setting unit that sets a target color temperature of the content data based on the first ratio and the second ratio; and
a converter that changes a color temperature of the content data to the target color temperature.

2. The signal processing device according to claim 1,
wherein the setting unit lowers the target color temperature as the first ratio becomes greater.

3. The signal processing device according to claim 1,
wherein the calculator excludes from the first area, an area having chroma of a background color that is equal to or greater than a predetermined value in the first area.

4. The signal processing device according to claim 1,
wherein the setting unit calculates a target color temperature of content data to be subsequently displayed, and then replaces a target color temperature of the content data currently being displayed with a color temperature between the target color temperature of the content data currently being displayed and the target color temperature of the content data to be subsequently displayed.

5. The signal processing device according to claim 1 further comprising a detector that detects a color temperature of ambient light,
wherein the setting unit sets a color temperature between the color temperature detected by the detector and the color temperature set in accordance with the first ratio and the second ratio calculated by the calculator, as a target color temperature.

6. A signal processing device comprising:
a calculator that divides a display area of content data into a plurality of areas including a first area for mainly displaying a character and a second area for mainly displaying an object other than character, and calculates each of a first ratio of the first area to the display area and a second ratio of the second area to the display area; and
a converter that changes a current color temperature of the content data to a target color temperature,
wherein the target color temperature is a color temperature that depends on a ratio between the first area and the second area.

7. A signal processing method comprising:
dividing a display area of content data into a plurality of areas including a first area for mainly displaying a character and a second area for mainly displaying an object other than character;
calculating each of a first ratio of the first area to the display area and a second ratio of the second area to the display area;
setting a target color temperature of the content data based on the first ratio and the second ratio; and
changing a present color temperature of the content data eventually to the set target color temperature.
